(19) United States
(12) Patent Application Publication
(10) Pub. No.: US 2012/0016592 A1
(43) Pub. Date: Jan. 19, 2012

(54) IMAGE DOMAIN SIGNAL TO NOISE ESTIMATE WITH BOREHOLE DATA

(75) Inventors: Brad Artman, Denver, CO (US); Benjamin Witten, Denver, CO (US)

(73) Assignee: SPECTRASEIS AG, ZURICH (CH)

(21) Appl. No.: 13/244,908

(22) Filed: Sep. 26, 2011

Related U.S. Application Data
(63) Continuation of application No. 13/145,328, filed on Jul. 19, 2011.
(60) Provisional application No. 61/145,865, filed on Jan. 20, 2009.

(51) Int. Cl. G01V 1/28; G06F 19/00

(52) U.S. Cl. 702/16

(57) ABSTRACT

A method and system for processing synchronous array seismic data includes acquiring synchronous passive seismic data from a plurality of sensors to obtain synchronized array measurements. A reverse-time data propagation process is applied to the synchronized array measurements to obtain a plurality of dynamic particle parameters associated with subsurface locations. Imaging conditions are applied to obtain imaging values that may be summed or stacked to obtain a time reverse image attribute. A volume of imaging values may be scaled by a non-signal noise function to obtain a modified image that is compensated for noise effects.

### BACKGROUND OF THE DISCLOSURE

1. Technical Field

The disclosure is related to seismic exploration for oil and gas, and more particularly to determination of the positions of subsurface reservoirs.

2. Description

Geophysical and geological exploration investment for hydrocarbons is often focused on acquiring data in the most promising areas using relatively slow methods, such as reflection seismic data acquisition and processing. The acquired data are used for mapping potential hydrocarbon-bearing areas within a survey area to optimize exploratory or production well locations and to minimize costly non-productive wells.

The time from mineral discovery to production may be shortened if the total time required to evaluate and explore a survey area can be reduced by applying geophysical methods alone or in combination. Some methods may be used as a standalone decision tool for oil and gas development decisions when no other data is available.

Geophysical and geological methods are used to maximize production after reservoir discovery as well. Reservoirs are analyzed using time lapse surveys (i.e. repeat applications of geophysical methods over time) to understand reservoir changes during production. The process of exploring for and exploiting subsurface hydrocarbon reservoirs is often costly and inefficient because operators have imperfect information from geophysical and geological characteristics about reservoir locations. Furthermore, a reservoir's characteristics may change as it is produced.

The impact of oil exploration methods on the environment may be reduced by using low-impact methods and/or by narrowing the scope of methods requiring an active source, including reflection seismic and electromagnetic surveying methods. Various geophysical data acquisition methods have a relatively low impact on field survey areas. Low-impact methods include gravity and magnetic surveys that maybe used to enrich or corroborate structural images and/or integrate with other geophysical data, such as reflection seismic data, to delineate hydrocarbon-bearing zones within promising formations and clarify ambiguities in lower quality data, e.g. where geological or near-surface conditions reduce the effectiveness of reflection seismic methods.

### SUMMARY

A method and system for processing synchronous array seismic data includes acquiring synchronous passive seismic data from a plurality of sensors to obtain synchronized array measurements. A reverse-time data propagation process is applied to the synchronized array measurements to obtain a plurality of dynamic particle parameters associated with subsurface locations. Imaging conditions are applied to obtain imaging values that may be summed or stacked to obtain a time reverse image attribute. A volume of imaging values may be scaled by a non-signal noise function to obtain a modified image that is compensated for noise effects.

### BRIEF DESCRIPTION OF THE DRAWINGS

FIG. 1 is a schematic illustration of a method according to an embodiment of the present disclosure for calculating a time reverse image attribute;

FIG. 2 illustrates various non-limiting possibilities for arrays of sensor for data acquisition of synchronous signals;

FIG. 3 is a flow chart of reverse-time processing for application to seismic data;

FIG. 4 is a flow chart of a data processing flow that includes reverse-time propagation processing of field data;

FIG. 5 illustrates a flow chart of a reverse-time propagation process to determine a time reverse imaging attribute;

FIG. 6 illustrates a flow chart according to an embodiment of the present disclosure for determining a signal to noise image that includes executing a time reverse image processing method with acquired seismic data as input;

FIG. 7 illustrates a flow chart for determining an image domain stack attribute;

FIG. 8 illustrates the output from a division of a ‘real’ dataset with a ‘random’ dataset to produce an image-domain signal to noise estimate;

FIG. 9 illustrates a 2-D profile result of summing imaging condition data output along the depth axis; and

FIG. 10 is diagrammatic representation of a machine in the form of a computer system within which a set of instructions, when executed may cause the machine to perform any one or more of the methods and processes described herein.

### DETAILED DESCRIPTION

Information to determine the location of hydrocarbon reservoirs may be extracted from naturally occurring seismic waves and vibrations measured at the earth's surface using passive seismic data acquisition methods. Seismic wave energy emanating from subsurface reservoirs, or otherwise altered by subsurface reservoirs, is detected by arrays of sensors and the energy back-propagated with reverse-time processing methods to locate the source of the energy disturbance. An imaging methodology for locating positions of subsurface reservoirs may be based on various time reversal processing algorithms of time series measurements of passive or active seismic data.

This disclosure teaches attributes extracted directly from energy focused or localized by the reverse time propagation. Additionally, this disclosure teaches that artificial or ambiguous focusing of reverse time images may be ameliorated or removed by accounting for the imaging artifacts velocity may introduce.

The methods disclosed here are equally applicable to seismic data acquired with so-called active or artificial sources or as part of a passive acquisition program. Passive seismic data acquisition methods rely on seismic energy from sources not directly associated with the data acquisition. In passive seismic monitoring there may be no actively controlled and triggered source. Examples of sources recorded that may be recorded with passive seismic acquisition are microseisms (e.g., rhythmically and persistently recurring low-energy earth tremors), microtremors and other ambient or localized seismic energy sources.

Microtremors are often attributed to the background energy normally present or occurring in the earth. Microtremor seismic waves may include sustained seismic signals within various or limited frequency ranges. Microtremor signals, like all seismic waves, contain information affecting spectral signature characteristics due to the media or environment that the seismic waves traverse as well as the source of the seismic energy. These naturally occurring, low amplitude and often relatively low frequency background seismic waves (sometimes termed noise or hum) of the earth may be generated from a variety of sources, some of which may be unknown or indeterminate.

Characteristics of microtremor seismic waves in the “infrasonic’ range may contain relevant information for direct detection of subsurface properties including the detection of fluid reservoirs. The term infrasonic may refer to sound waves below the frequencies of sound audible to humans, and nominally includes frequencies under 20 Hz.

Synchronous arrays of sensors are used to measure vertical and horizontal components of motion due to background seismic waves at multiple locations within a survey area. The sensors measure orthogonal components of motion simultaneously.

Local acquisition conditions within a geophysical survey may affect acquired data results. Acquisition conditions impacting acquired signals may change over time and may be diurnal. Other acquisition conditions are related to the near sensor environment. These conditions may be accounted for during data reduction.

The sensor equipment for measuring seismic waves may be any type of seismometer for measuring particle dynamics, such as particle displacements or derivatives of displacements. Seismometer equipment having a large dynamic range and enhanced sensitivity compared with other transducers, particularly in low frequency ranges, may provide optimum results (e.g., multicomponent earthquake seismometers or equipment with similar capabilities). A number of commercially available sensors utilizing different technologies may be used, e.g. a balanced force feed-back instrument or an electrochemical sensor. An instrument with high sensitivity at very low frequencies and good coupling with the earth enhances the efficacy of the method. The data measurements may be recorded as particle velocity values, particle acceleration values or particle pressure values.

Noise conditions representative of seismic waves that may have not traversed or been affected by subsurface reservoirs can negatively affect the recorded data. Techniques for removing unwanted noise and artifacts and artificial signals from the data, such as cultural and industrial noise, are important where ambient noise is relatively high compared with desired signal energy.

Time-reverse data propagation may be used to localize relatively weak seismic events or energy, for example if a reservoir acts as an energy source, an energy scatterer or otherwise significantly affects acoustic energy traversing the reservoir, thereby allowing the reservoir to be located. The seismograms measured at a synchronous array of sensor stations are reversed in time and used as boundary values for the reverse processing. A time-reversed seismic wave field is injected into the earth model at the sensor position and propagated through the model. Various imaging conditions may be applied to enhance the processing that localizes the events or energy. Time-reverse data processing is able to localize event or energy sources with extremely low S/N-ratios.

Field surveys have shown that hydrocarbon reservoirs may act as a source of low frequency seismic waves and these signals are sometimes termed “hydrocarbon microtremors.” The frequency ranges of microtremors have been reported between ˜1 Hz to 6 Hz or greater. A direct and efficient detection of hydrocarbon reservoirs is of central interest for the development of new oil or gas fields. If there is a steady source origin (or other wave field alteration) of low-frequency seismic waves within a reservoir, the location of the reservoir may be located using time reverse propagation combined with the application of one or more imaging conditions. Time reverse propagation may be associated with wave field decomposition. The output of this processing can be used to locate and differentiate stacked reservoirs.

Time reverse propagation of acquired seismic data, which may be in conjunction with modeling, using a grid of nodes is an effective tool to detect the locality of an origin of low-frequency seismic waves. As a non-limiting example for the purposes of illustration since microtremor characteristics are variable over time and space, as well as affected by subsurface structure and near surface conditions, microtremors may comprise low-frequency signals with a fundamental frequency of about 3 Hz and a range between 1.5 Hz and 4.5 Hz. Hydrocarbon affected seismic data that include microtremors may have differing values that are reservoir or case specific. Processed data images representing one or more time steps showing a dynamic particle motion value (e.g., displacement, velocity, acceleration or pressure) at every grid point may be produced during the reverse-time signal processing. Data for grid nodes or earth-model areas representing high or maximum particle velocity values may indicate the location of a specific source (or a location related to seismic energy source aberration) of the forward or field acquired data. The maximum dynamic particle parameters at model grid nodes obtained from the reverse-time data propagation may be used to delineate parameters associated with the subsurface reservoir location. Alternative imaging conditions useful with reverse time imaging of subsurface energy sources include combinations of particle dynamic behaviors and relationships, including phase and wave mode relationships.

There are many known methods for a reverse-time data process for seismic wave field imaging with Earth parameters from acquired seismic data. For example, finite-difference, ray-tracing and pseudo-spectral computations, in two- and three-dimensional space, are used for full or partial wave field simulations and imaging of seismic data. Reverse-time propagation algorithms may be based on finite-difference, ray-tracing or pseudo-spectral wave field extrapolators. Output from these reverse-time data processing routines may include amplitudes for displacement, velocity, acceleration or pressures values at every time step of the imaging.

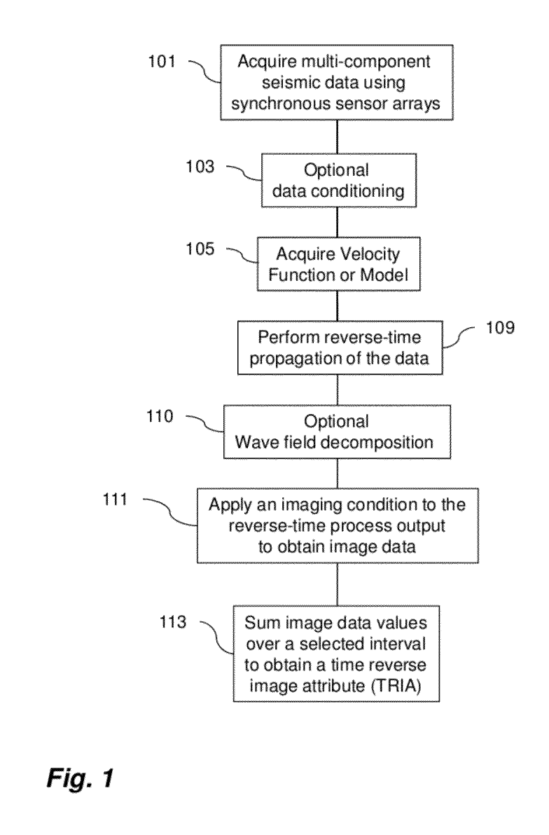

FIG. 1 illustrates a method according to a non-limiting embodiment of the present disclosure that includes acquiring seismic data to determine a subsurface location for hydrocarbons or other reservoir fluids. The embodiment, which may include one or more of the following (in any order), includes acquiring synchronous array seismic data having a plurality of components 101. The acquired data from each sensor station may be time stamped and include multiple data vectors. An example is passive seismic data, such as multicomponent seismometry data from long period sensors, although “passive acquisition” is not a requirement. The multiple data vectors may each be associated with an orthogonal direction of movement. The vector data may be arbitrarily mapped or assigned to any coordinate reference system, for example designated east, north and depth (e.g., respectively, Ve, Vn and Vz) or designated Vₓ, V_{y} and V_{z} according to any desired convention and is amenable to any coordinate system.

The data may be optionally conditioned or cleaned as necessary 103 to account for unwanted noise or signal interference. For example various processing steps such as offset removal, detrending the signal and band pass or other targeted frequency filtering or any other seismic data processing/conditioning methods as known by practitioners in the seismic arts. The vector data may be divided into selected time windows for processing. The length of time windows for analysis may be chosen to accommodate processing or operational concerns.

Additionally, signal analysis, filtering, and suppressing unwanted signal artifacts may be carried out efficiently using transforms applied to the acquired data signals. The data may be resampled to facilitate more efficient processing. If a preferred or known range of frequencies for which a hydrocarbon signature is known or expected, an optional frequency filter (e.g., zero phase, Fourier of other wavelet type) may be applied to condition the data for processing. Examples of basis functions for filtering or other processing operations include without limitation the classic Fourier transform or one of the many Continuous Wavelet Transforms (CWT) or Discrete Wavelet Transforms. Examples of other transforms include Haar transforms, Haademard transforms and Wavelet Transforms. The Morlet wavelet is an example of a wavelet transform that often may be beneficially applied to seismic data. Wavelet transforms have the attractive property that the corresponding expansion may be differentiable term by term when the seismic trace is smooth.

Imaging using field-acquired passive seismic data, or any seismic data, to determine the location of subsurface reservoirs includes using the acquired time-series data as ‘sources’ in reverse-time wave propagation, which requires velocity information 105. This velocity information may be a known function of position or explicitly defined with a velocity model. A reverse-time propagation of the data 109 is performed by injecting the time-reversed wave-field at the recording stations. The output of the reverse-time processing includes one or more measures of the dynamic particle motion of sources associated with subsurface positions (which may be nodes of mathematical descriptions (i.e., models) of the earth).

Optionally, wave equation decomposition 110 may be applied to the data undergoing reverse time propagation to facilitate various imaging conditions to apply to the data. An imaging condition is applied to the dynamic particle motion output during the reverse-time processing 111. The final output of the reverse-time processing depends on the imaging condition or conditions used. Imaging conditions are developed in more detail below and include one or of: Eₚ(x,t)=P(x,t)²=(λ+2μ)(∇·\vec{u}|ₜ)², Eₛ(x,t)=S(x,t)²=μ(−∇×\vec{u}|ₜ)², Iₚ(x)=ΣₜP(x,t)P(x,t), Iₛ(x)=ΣₜS(x,t)S(x,t), Iₚₛ(x)=ΣₜP(x,t)S(x,t), and Iₑ(x)=ΣₜEₚ(x,t)Eₛ(x,t). The imaging condition output values may be summed 113 over in interval, in depth or time, horizontally or vertically, to aid in the determination of the location of the energy source or the reservoir location.

For the purposes of illustrating one embodiment of the time reverse imaging attribute (TRIA), selecting the maximum dynamic particle motion output at any node during the reverse time propagation is used as an example of an imaging condition. However, it will be appreciated that the TRIA is applicable for use with any imaging condition, including examples associated with wave-field decompositions described later herein. For this example, the maximum values derived from dynamic particle motion, which may be displacements, velocities or accelerations, may be collected to determine the energy source location contributing to the dynamics. Plotting the maximum dynamic values across all nodes may provide a basis for interpreting the location of a subsurface reservoir. A TRIA is determined 115 by summing the amplitude values along selected intervals in depth or time to indicate the position of a reservoir that is the source of hydrocarbon tremors. The data may be contoured or otherwise graphically displayed to illuminate reservoir positions.

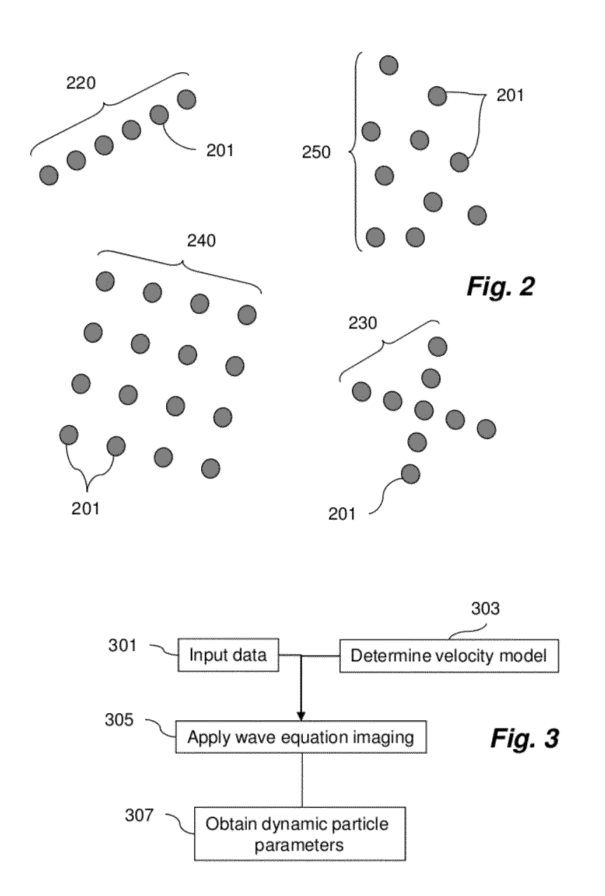

Field data may be acquired with surface arrays, which may be 2D or 3D, or even arbitrarily positioned sensors 201 as illustrated in FIG. 2. FIG. 2 illustrates various acquisition geometries which may be selected based on operational considerations. Array 220 is an array for acquiring a 2D dataset (distance and time) and while illustrated with regularly spaced sensors 201, regular distribution is not a requirement. Array 230 and 240 are example illustrations of arrays for acquiring 3D datasets. Sensor distribution 250 could be considered an array of arbitrarily placed sensors and may even provide for some modification of possible spatial aliasing that can occur with regular spaced sensor 201 acquisition arrays.

While data may be acquired with multi-component earthquake seismometer equipment with large dynamic range and enhanced sensitivity, many different types of sensor instruments can be used with different underlying technologies and varying sensitivities. Sensor positioning during recording may vary, e.g. sensors may be positioned on the ground, below the surface or in a borehole. The sensor may be positioned on a tripod or rock-pad. Sensors may be enclosed in a protective housing for ocean bottom placement. Wherever sensors are positioned, good coupling results in better data. Recording time may vary, e.g. from minutes to hours or days. In general terms, longer-term measurements may be helpful in areas where there is high ambient noise and provide extended periods of data with fewer noise problems.

The layout of a data survey may be varied, e.g. measurement locations may be close together or spaced widely apart and different locations may be occupied for acquiring measurements consecutively or simultaneously. Simultaneous recording of a plurality of locations (a sensor array) may provide for relative consistency in environmental conditions that may be helpful in ameliorating problematic or localized ambient noise not related to subsurface characteristics of interest. Additionally the array may provide signal differentiation advantages due to commonalities and differences in the recorded signal.

A non-limiting example of a reverse-time processing imaging is illustrated in FIG. 3 wherein seismic data are input 301 to the processing flow. The data may optionally be filtered to a selected frequency range. A velocity model for the reverse-time process may be determined from known information 303 or estimated. A wave-equation reverse-time imaging is performed 305 to obtain particle dynamic behavior 307.

The reverse-time propagation process may include development of an earth model based on a priori knowledge or estimates of physical parameters of a survey area of interest. During data preparation, forward modeling may be useful for anticipating and accounting for known seismic signal or refining the velocity model or functions used for the reverse time processing. Modeling may include accounting for, or the removal of, the near sensor signal contributions due to environmental field effects and noise and, thus, the isolation of those parts of acquired data signals believed to be associated with environmental components being examined. By adapting or filtering the data between successive iterations in the imaging process, predicted signal can be obtained, thus allowing convergence to a structure element indicating whether a reservoir is present within the subsurface.

Time-reverse imaging (TRI) locates sources from acoustic, elastic, EM or optical measurements. It is the process of injecting a time reversed wave field at the recording locations and propagating the wave field through an earth model. A TRM result contains the complete time axis which an observer visually scans through to locate energetic focus locations (e.g., using velocity particle maxima). These focal locations are indicative of the constructive interference of energy at a source location.

However, rather than maintain the time axis, it can be collapsed by applying an imaging condition (IC) to produce a single image in physical space. The chain of operations of propagating a time-reversed wave field through a model and applying an imaging condition is referred to as time-reverse imaging (TRI).

When recording the ambient seismic wave field, multi-component sensors are placed at discrete locations. Therefore, when injecting the data into the model domain, point sources are created at recording locations. After sufficient propagation steps, the full wave field will be approximated. The depth at which the sampled wave field approximates the full wave field is a function of spatial sampling and the velocity model parameters, but is usually 1 to 1.5 times the spatial sampling.

From a multi-component data set, individual propagation modes are extracted from the full wave field. For the isotropic case, two vector identities are required to separate the P- and S-wave modes from the full displacement wave-field u(x,t) at each time step. For two-dimensional models x refers to the spatial dimensions (x, z). Without loss of generality, x can also refer to the 3-dimensional (x, y, z) case. The wave field decomposition step is inserted into the TRI algorithm before applying the imaging condition. Since the curl of the irrotational potential is zero and the divergence of the solenoidal potential is zero, the compressional, Eₚ(x,t), and shear, Eₛ(x,t), kinetic energy densities are Eₚ(x,t)=P(x,t)²=(λ+2μ)(∇·\vec{u}|ₜ)², and Eₛ(x,t)=S(x,t)²=μ(−∇×\vec{u}|ₜ)², where λ and μ are the Lame coefficients. The derivatives are evaluated at each time step, t.

Separating the wave field allows for multiple imaging conditions to be applied based upon the expected source type. These imaging conditions are based on extracting the zero-lag of a cross-correlation along the time axis at every spatial location. The imaging conditions are the zero-lag of the P-wave autocorrelation, Iₚ, the zero-lag of the S-wave autocorrelation, Iₛ, the zero-lag of the P- and S-wave cross-correlation, Iₚₛ, and the zero-lag of the cross-correlation of the P- and S-wave energy densities, Iₑ. These imaging conditions are expressed as: Iₚ(x)=ΣₜP(x,t)P(x,t), Iₛ(x)=ΣₜS(x,t)S(x,t), Iₚₛ(x)=ΣₜP(x,t)S(x,t), and Iₑ(x)=ΣₜEₚ(x,t)Eₛ(x,t).

These image conditions, except for the cross-correlation of the P- and S-waves, have squared the wave field components, and thus produce non-negative images. The cross-correlation of the P- and S-waves has 0-mean, and has a zero-crossing at the source location, which is a function of the source type.

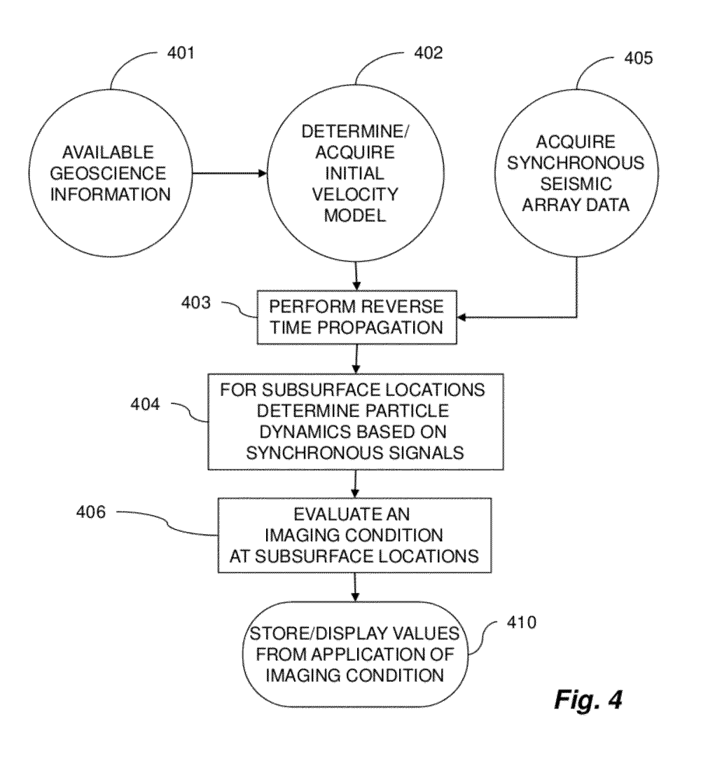

FIG. 4 illustrates an example of reverse-time imaging for locating an energy source or a reservoir in the subsurface using a velocity model 402 as input. The reverse time propagation may be wave equation based. Any available geoscience information 401 may be used as input to determine parameters for an initial model 402 that may be modified as input to a reverse-time data propagation process 403 as more information is available or determined. Synchronously acquired passive seismic data 405 are input (after any optional processing/conditioning) to the reverse-time propagation process 403. Particle dynamics such as displacement, velocity or acceleration (or pressure) are determined from the processed data for determining dynamic particle behaviour 404. For the data range processed for reverse time propagation, an imaging condition 406 is applied. The imaging condition may be one or more of: Eₚ(x,t)=P(x,t)²=(λ+2μ)(∇·\vec{u}|ₜ)², Eₛ(x,t)=S(x,t)²=μ(−∇×\vec{u}|ₜ)², Iₚ(x)=ΣₜP(x,t)P(x,t), I_{S}(x)=ΣₜS(x,t)S(x,t), Iₚₛ(x)=ΣₜP(x,t)S(x,t), and Iₑ(x)=ΣₜEₚ(x,t)Eₛ(x,t). The output from the application of the imaging condition is stored or displayed 410 to determine subsurface reservoir positions. Alternatively, other imaging conditions may be applied, including imaging conditions determined for seismic data using wave field decomposition.

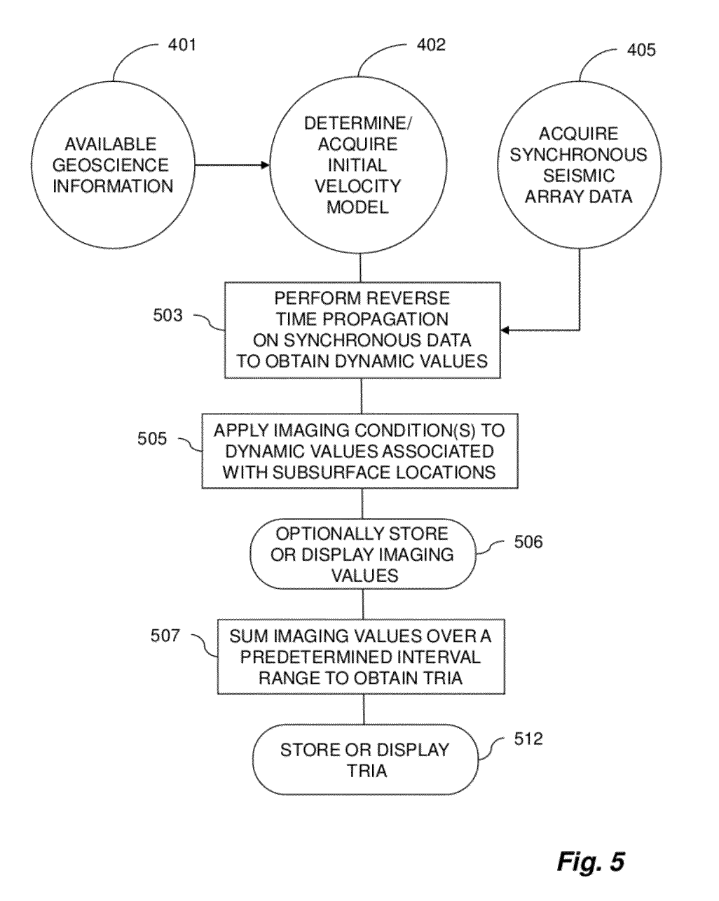

FIG. 5 illustrates an example of a reverse-time propagation process to determine a time reverse imaging attribute (TRIA) useful for locating a reservoir or energy source in the subsurface using a velocity model 402 as input for a reverse-time imaging. The reverse time imaging may be wave equation based. Any available geoscience information 401 may be used as input to determine parameters for an initial model 402 that may be modified as input to reverse-time data propagation 503 as more information is available or determined. Synchronously acquired seismic data 405 are input (after any optional processing/conditioning) to the reverse-time data process 503. One or more imaging conditions are applied to the time-reversed data to obtain imaging values 505 associated with subsurface locations. The imaging condition may be one or more of: Eₚ(x,t)=P(x,t)²=(λ+2μ)(∇×\vec{u}|ₜ)², E_{S}(x,t)=S(x,t)²=μ(−∇×\vec{u}|ₜ)², Iₚ(x)=ΣₜP(x,t)P(x,t), I_{S}(x)=ΣₜS(x,t)S(x,t), Iₚₛ(x)=ΣₜP(x,t)S(x,t), and Iₑ(x)=ΣₜEₚ(x,t)Eₛ(x,t). The imaging values may optionally be stored or displayed 506. These output values, which depending on the selected imaging condition may be proportional to energy, are representative over the subsurface volume of the energy that has originated from the associated subsurface location. TRIA is obtained for a selected interval (in time or depth) by summing the values over the selected interval 507. The TRIA may be projected to the earth surface or a subsurface horizon in association with a surface sensor position or any arbitrary position to provide an indication of areal extent of a subsurface energy source anomaly or hydrocarbon reservoir. The TRIA may be stored or displayed 512.

An example of an embodiment illustrated here uses a numerical modeling algorithm similar to a rotated staggered grid finite-difference technique. The two dimensional numerical grid is rectangular. Computations may be performed with second order spatial explicit finite difference operators and with a second order time update. However, as will be well known by practitioners familiar with the art, many different reverse-time methods may be used along with various wave equation approaches. Extending methods to three dimensions is straightforward.

In one non-limiting embodiment a method and system for processing synchronous array seismic data includes acquiring synchronous passive seismic data from a plurality of sensors to obtain synchronized array measurements. A reverse-time data propagation process is applied to the synchronized array measurements to obtain a plurality of dynamic particle parameters associated with subsurface locations. These dynamic particle parameters are stored in a form for display. Maximum values of the dynamic particle parameters may be interpreted as reservoir locations. The dynamic particle parameters may be particle displacement values, particle velocity values, particle acceleration values or particle pressure values. The sensors may be three-component sensors. Zero-phase frequency filtering of different ranges of interest may be applied. The data may be resampled to facilitate efficient data processing.

A system response is the convolution of a seismic signal with a velocity model. Different velocity models engender different responses to the same seismic input. Particular models may have system responses that obscure the source locations even with high signal to noise ratios. An example is the “ringing” in low velocity layers. The system response to field data will contain contributions from signal, noise and sampling artifacts. To accurately interpret the signal contribution, it is important to estimate and remove the any portion of a system response to non-signal components. A non-signal noise data set may be used to remove non-signal contributions to a system response.

A non-signal noise-dataset may be developed from noise traces from an appropriate noise model containing seismic data scaled to the amplitude and frequency band of the acquired field data. This ensures that the noise traces have equal energy to the recorded traces but without any correlated phase information. The advantage of this type of noise model is that it is based directly on the data. No information about the acquisition environment is necessary. The noise model seismic data may be generated from random input or forward modeling.

Once created, the non-signal noise-dataset is imaged with the TRI algorithm in the same fashion with the same velocity field as the field seismic data. This synthetic image derived using the velocity field will estimate the system response to both the non-signal noise-dataset and sampling artifacts. In this way, it is possible to create an estimate of the signal to noise ratio in the image domain. The recorded data, d, is a combination of signal and noise: d=s+n. The image created from this data is the apparent signal image, S. Using capital letters to indicate images as a function of space, eg S(x) and lower case letters for recordings that functions of space and time, eg d(x,t), the apparent signal for the recorded data is defined as: S=Σₜ(sₜ+nₜ)²=Σₜsₜ²+2sₜnₜ+nₜ², where the time-axis is summed over t. Dropping the subscript, the estimated noise image, \ddot{N}, is \ddot{N}=Σ\ddot{n}², where \ddot{n} is the noise data. The estimated signal image, \ddot{S}, is \ddot{S}=S−\ddot{N}.

A signal to noise estimate may be obtained by dividing the apparent signal by the noise estimate. The estimated signal to noise image is

$$\frac{\tilde{S}}{\tilde{N}} + 1 = \frac{S}{\tilde{N}} = \frac{Σ {s}^{2}}{Σ {\tilde{n}}^{2}} + 2 \frac{Σ sn}{Σ {\tilde{n}}^{2}} + \frac{Σ {n}^{2}}{Σ {\tilde{n}}^{2}} .$$

For noise estimated correctly, n≈\ddot{n} and

$$\frac{Σ {n}^{2}}{Σ {\tilde{n}}^{2}} \approx 1.$$

Therefore, the division of dataset S with dataset \ddot{N} results in an estimated signal to noise image.

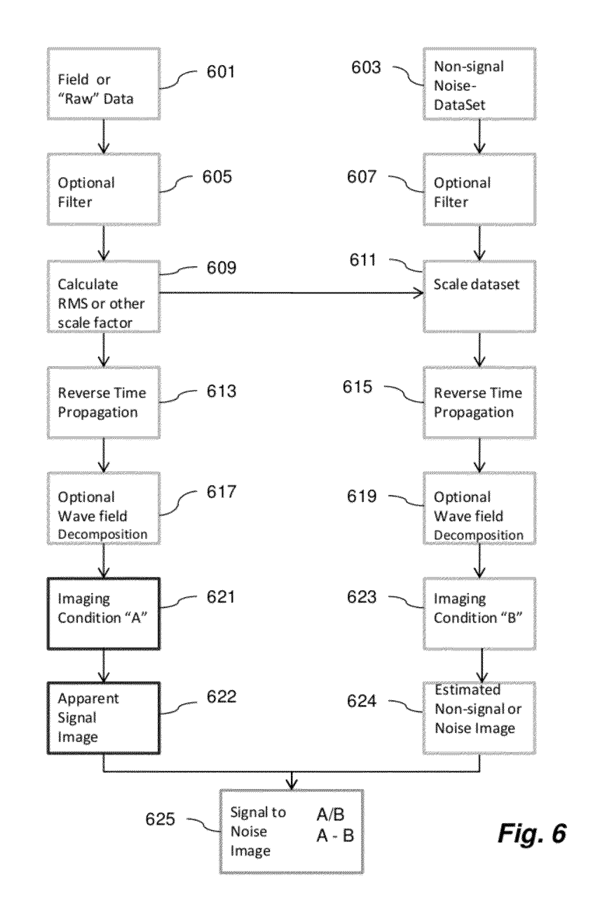

FIG. 6 illustrates a flow chart according to an embodiment of the present disclosure for determining a noise domain signal to noise image estimate that includes executing a time reverse image processing method with acquired seismic data 601 as input. The method includes estimating or compensating for the signal to noise ratio in the image domain. The process includes two essentially parallel processes including the input of a non-signal noise dataset 603 containing a substantially equivalent amount of energy and frequency content as the acquired seismic data 601 at each sensor or acquisition station for all components. The non-signal noise dataset may be developed from substantially random data or a forward modeling process may be used to determine the non-signal noise dataset if parameters are available. When both the real seismic data 601 and non-signal 603 data are processed through to an imaging condition result, the images are divided or otherwise compared (e.g., Real image output divided by the non-signal image output) or otherwise processed together to determine where energy originating in the subsurface focuses 625.

Following a reverse time propagation process similar to FIG. 4, the synchronously acquired seismic array data 601 may be optionally filtered 605 or otherwise processed to remove transients and noise. A scaling value (e.g. an RMS value determined from the seismic data) is calculated 609 that may also be used as an input parameter (611) for the nonsignal noise dataset sequence processing. Reverse time propagation (which may be referred to as acausal elastic propagation) is applied to the data 613 (e.g., FIG. 4). Acausal propagation of the data, or causal propagation of time-reversed data, will position the data through time to the location of the source.

Optionally, the wavefield may be decomposed 617 so that one or more of the imaging conditions referred to above 621, for example an imaging condition arbitrarily designated “A” that may be one or more of Iₚ, Iₛ, Iₚₛ and/or Iₑ.

Random input seismic data 603 undergoes a similar processing sequence. The data may be optionally filtered 607 in the same or equivalent manner to 605 and may be scaled 611 by the RMS or other scaling value calculated at 609. The data are propagated through the velocity model 615, as in 613, and the wavefield decomposed 619. An imaging condition “B” (that may be imaging condition “A”) is applied to the decomposed data. After application of the selected imaging condition the output is an apparent signal image 622 or an estimated noise image 624. The estimated noise image 624, generated from the non-signal noise dataset, may optionally be smoothed. The data determined at 622 and 624 may then be divided or otherwise scaled, for example the data output from 622 may be divided by the data output from 624, which results in a signal to noise image 625. This signal to noise image 625 may be considered as the effective removal of an image system response related to the velocity model.

Another embodiment according to the present disclosure comprises an image domain stack: After TRM or TRI processing, the image data or dynamic particle values are stacked vertically in time or depth to obtain a TRI attribute (TRIA). The stacking may be over a selected interval of interest or substantially the entire vertical depth or time range of the time reverse imaging. This attribute may be displayed in map form over the area of the seismic data acquisition, which results in the TRIA projected to the surface. This gives a surface map of where the energy is accumulating over the survey area. The data values projected to the surface may be contoured or otherwise processed for display. In some circumstances (for example sparse spatial sampling resulting in strong apparent near surface effects) it may be best to exclude the near surface from the TRIA determination.

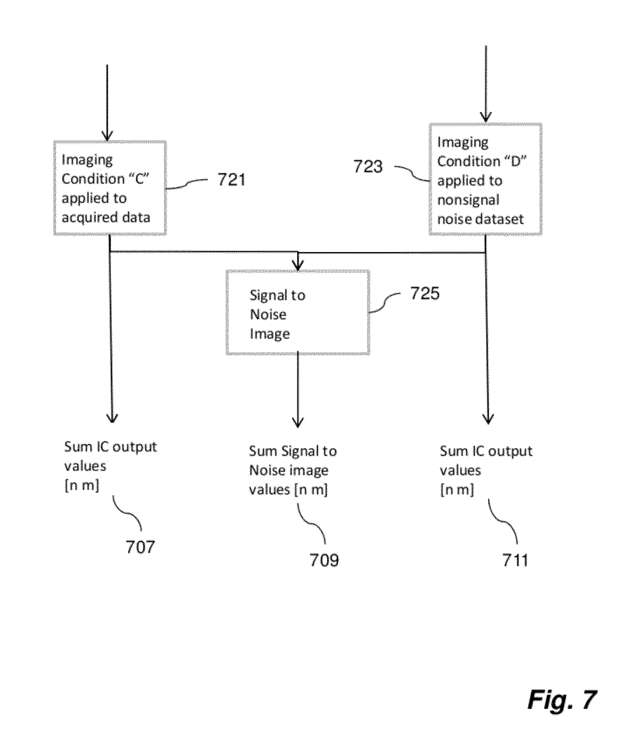

FIG. 7 illustrates that data processed to Imaging Condition “C” 721 that may, for example, be an imaging condition applied to a decomposed wavefield of acquired seismic data may then be summed 707 along the depth or time axis. Alternatively, the imaging condition (IC) output may be summed along a horizontal interval or a known horizon interval. Imaging Condition “D” 723, applied to a non-signal noise dataset, which imaging condition may be equivalent to 721, but for a non-signal noise dataset or a time separated dataset may be combined with data from 721 at 725 to remove the impulse response prior to stacking along the depth axis 709. The data from 723 may also be summed 711 (as in 707) for comparison as well. These output values may also be projected to the surface and contoured.

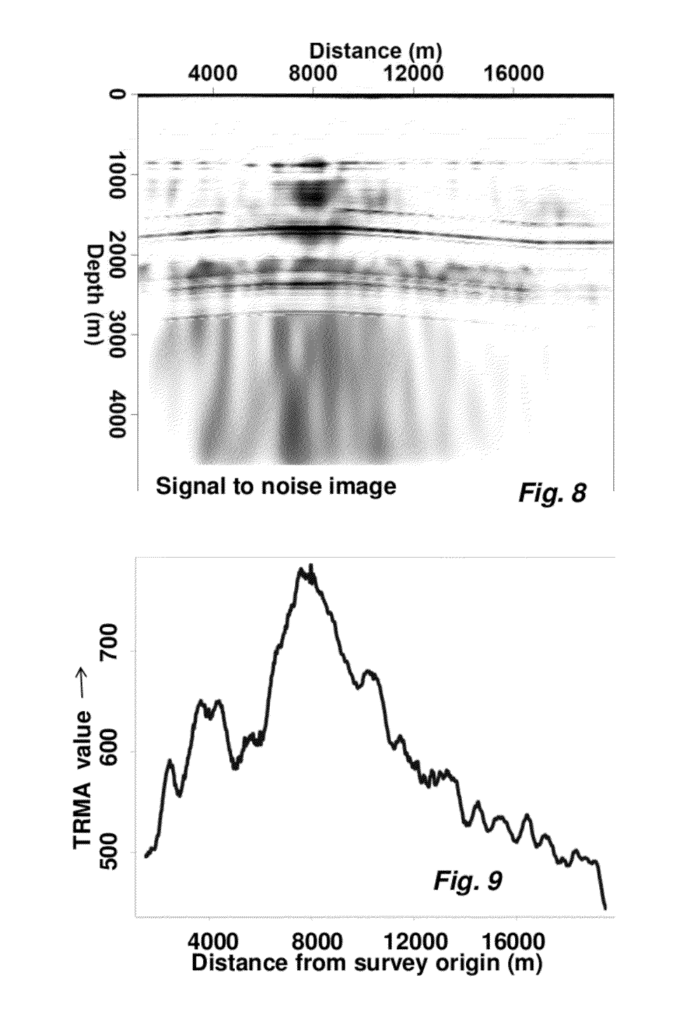

FIG. 8 illustrates a signal to noise image, or an image-domain signal to noise estimate, an example of the output of 625, the output of the division of a ‘real’ dataset using field acquired seismic data, for example at step 622, by a dataset from the same location using the non-signal noise dataset input processed to an imaging condition representing an estimate of the noise, for example like 624 of FIG. 6. The advantage is that energy that may appear to focus in parts of the depth model is accounted for since the enhanced focus of random energy is accounted for in the output of this processing.

FIG. 9 illustrates an example of the TRIA over a surface profile obtained by stacking the data (arbitrary vertical axis units) from the imaging condition result along the vertical axis (depth in this case) of the processing illustrated in FIG. 8. In this case the near surface is not included since the numerical artifacts due to the relatively sparse near surface spatial sampling are strong and do not apparently contain accurate information. Alternatively, the data may be stacked or summed horizontally or along or in depth or time horizons.

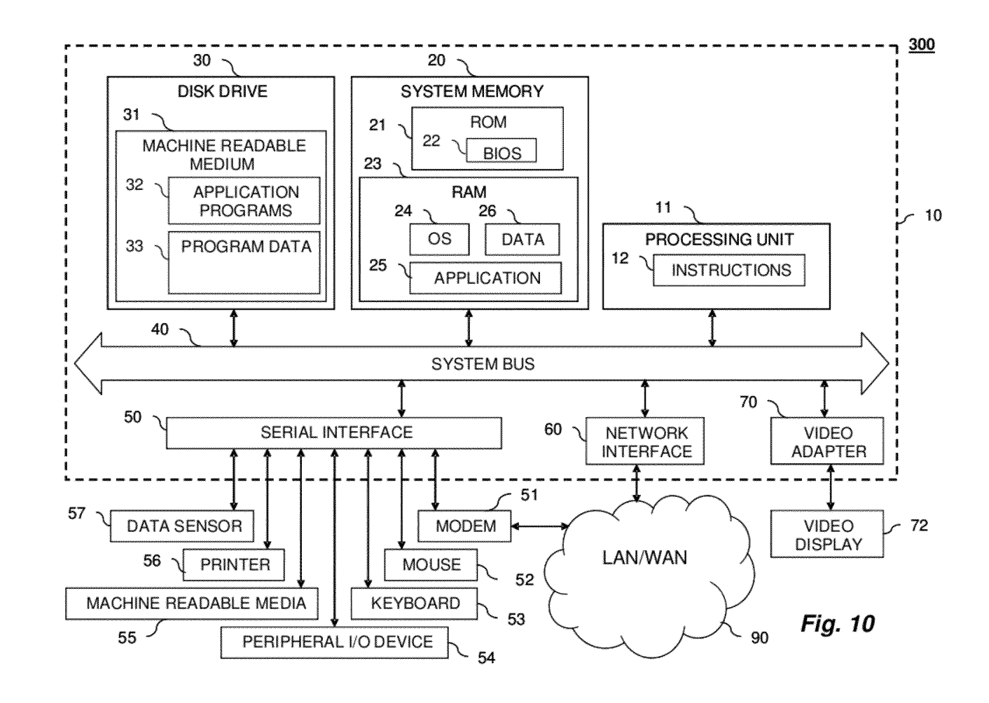

FIG. 10 is illustrative of a computing system and operating environment 300 for implementing a general purpose computing device in the form of a computer 10. Computer 10 includes a processing unit 11 that may include ‘onboard’ instructions 12. Computer 10 has a system memory 20 attached to a system bus 40 that operatively couples various system components including system memory 20 to processing unit 11. The system bus 40 may be any of several types of bus structures using any of a variety of bus architectures as are known in the art.

While one processing unit 11 is illustrated in FIG. 10, there may be a single central-processing unit (CPU) or a graphics processing unit (GPU), or both or a plurality of processing units. Computer 10 may be a standalone computer, a distributed computer, or any other type of computer.

System memory 20 includes read only memory (ROM) 21 with a basic input/output system (BIOS) 22 containing the basic routines that help to transfer information between elements within the computer 10, such as during start-up. System memory 20 of computer 10 further includes random access memory (RAM) 23 that may include an operating system (OS) 24, an application program 25 and data 26.

Computer 10 may include a disk drive 30 to enable reading from and writing to an associated computer or machine readable medium 31. Computer readable media 31 includes application programs 32 and program data 33.

For example, computer readable medium 31 may include programs to process seismic data, which may be stored as program data 33, according to the methods disclosed herein. The application program 32 associated with the computer readable medium 31 includes at least one application interface for receiving and/or processing program data 33. The program data 33 may include seismic data acquired according to embodiments disclosed herein. At least one application interface may be associated with applying an imaging condition and summing the image values along an interval for locating subsurface hydrocarbon reservoirs or energy sources.

The disk drive may be a hard disk drive for a hard drive (e.g., magnetic disk) or a drive for a magnetic disk drive for reading from or writing to a removable magnetic media, or an optical disk drive for reading from or writing to a removable optical disk such as a CD ROM, DVD or other optical media.

Disk drive 30, whether a hard disk drive, magnetic disk drive or optical disk drive is connected to the system bus 40 by a disk drive interface (not shown). The drive 30 and associated computer-readable media 31 enable nonvolatile storage and retrieval for application programs 32 and data 33 that include computer-readable instructions, data structures, program modules and other data for the computer 10. Any type of computer-readable media that can store data accessible by a computer, including but not limited to cassettes, flash memory, digital video disks in all formats, random access memories (RAMs), read only memories (ROMs), may be used in a computer 10 operating environment.

Data input and output devices may be connected to the processing unit 11 through a serial interface 50 that is coupled to the system bus. Serial interface 50 may a universal serial bus (USB). A user may enter commands or data into computer 10 through input devices connected to serial interface 50 such as a keyboard 53 and pointing device (mouse) 52. Other peripheral input/output devices 54 may include without limitation a microphone, joystick, game pad, satellite dish, scanner or fax, speakers, wireless transducer, etc. Other interfaces (not shown) that may be connected to bus 40 to enable input/output to computer 10 include a parallel port or a game port. Computers often include other peripheral input/output devices 54 that may be connected with serial interface 50 such as a machine readable media 55 (e.g., a memory stick), a printer 56 and a data sensor 57. A seismic sensor or seismometer for practicing embodiments disclosed herein is a nonlimiting example of data sensor 57. A video display 72 (e.g., a liquid crystal display (LCD), a flat panel, a solid state display, or a cathode ray tube (CRT)) or other type of output display device may also be connected to the system bus 40 via an interface, such as a video adapter 70. A map display created from spectral ratio values as disclosed herein may be displayed with video display 72.

A computer 10 may operate in a networked environment using logical connections to one or more remote computers. These logical connections are achieved by a communication device associated with computer 10. A remote computer may be another computer, a server, a router, a network computer, a workstation, a client, a peer device or other common network node, and typically includes many or all of the elements described relative to computer 10. The logical connections depicted in FIG. 10 include a local-area network (LAN) or a wide-area network (WAN) 90. However, the designation of such networking environments, whether LAN or WAN, is often arbitrary as the functionalities may be substantially similar. These networks are common in offices, enterprise-wide computer networks, intranets and the Internet.

When used in a networking environment, the computer 10 may be connected to a network 90 through a network interface or adapter 60. Alternatively computer 10 may include a modem 51 or any other type of communications device for establishing communications over the network 90, such as the Internet. Modem 51, which may be internal or external, may be connected to the system bus 40 via the serial interface 50.

In a networked deployment computer 10 may operate in the capacity of a server or a client user machine in server-client user network environment, or as a peer machine in a peer-to-peer (or distributed) network environment. In a networked environment, program modules associated with computer 10, or portions thereof, may be stored in a remote memory storage device. The network connections schematically illustrated are for example only and other communications devices for establishing a communications link between computers may be used.

In one nonlimiting embodiment a method for processing synchronous array seismic data comprises acquiring seismic data from a plurality of sensors to obtain synchronized array measurements, applying a reverse-time data propagation process to the synchronized array measurements to obtain dynamic particle parameters associated with subsurface locations, applying an imaging condition, using a processing unit, to the dynamic particle parameters to obtain imaging values associated with subsurface locations and summing the imaging values over a selected interval to obtain a time reverse image attribute.

Another aspect includes storing the time reverse image attribute in a form for display.

Still another aspect includes selecting synchronized array measurements for input to the reverse-time data propagation process without reference to phase information of the seismic data. In another aspect the synchronized array measurements comprises are at least one selected from the group consisting of i) particle velocity measurements, ii) particle acceleration measurements, iii) particle pressure measurements and iv) particle displacement measurements. The plurality of sensors may be three-component sensors.

In another aspect the time reverse image attribute may be scaled over the selected interval by a summed synthetic time reverse image attribute determined by applying the reverse time data process to synthetic seismic data, applying the imaging condition to the output of the reverse time data process and summing the synthetic imaging values over the selected interval. The method may further comprise applying a zero-phase frequency filter to the synchronized array measurements.

In another nonlimiting embodiment a set of application program interfaces embodied on a computer readable medium for execution on a processor in conjunction with an application program for applying a reverse-time data process to synchronized seismic data array measurements to obtain a time reverse image attribute associated with subsurface reservoir locations comprises a first interface that receives synchronized seismic data array measurements, a second interface that receives a plurality of dynamic particle parameters associated with a subsurface location, the parameters output from reverse-time data processing of the synchronized seismic data array measurements, a third interface that receives instruction data for applying an imaging condition to the dynamic particle parameters and a fourth interface that receives instruction data for summing output of the applied imaging condition along a selected interval to obtain a time reverse image attribute.

In another aspect the set of application interface programs further comprises a display interface that receives instruction data for displaying imaging-condition processed values of the plurality of dynamic particle parameters. Still another aspect comprises a velocity-model interface that receives instruction data for reverse-time propagation using a velocity structure associated with the synchronized seismic data array measurements. Yet another aspect of the set of application interface programs comprises a migration-extrapolator interface that receives instruction data for including an extrapolator for at least one selected from the group of i) finite-difference time reverse migration, ii) ray-tracing reverse time migration and iii) pseudo-spectral reverse time migration. Another aspect comprises an imaging-condition interface that receives instruction data for applying an imaging condition to dynamic particle parameters output from reverse-time data processing of synthetic seismic data array measurements to obtain synthetic image values. Another aspect of the application interface programs comprises an attribute-scaling interface that receives instruction data for scaling the time reverse image attribute by a function of a value determined by summing the synthetic image values along the selected interval. In still another aspect the set of application interface programs comprises a seismic-data-input interface that receives instruction data for the input of the plurality of seismic data array measurements that are at least one selected from the group consisting of i) particle velocity measurements, and ii) particle acceleration measurements and iii) particle pressure measurements.

In still another nonlimiting embodiment an information handling system for determining a time reverse image attribute for determining the presence of subsurface hydrocarbons associated with an area of seismic data acquisition comprises a processor configured for applying a reverse-time data process to synchronized array measurements of seismic data to obtain dynamic particle parameters associated with subsurface locations, a processor configured for summing imaging values obtained from applying an imaging condition to the dynamic particle parameters associated with subsurface locations, the values summed along an interval to obtain a time-reversed-model-attribute and a computer readable medium for storing the time-reversed-model-attribute.

Another aspect of the information handling system is wherein the processor is configured to apply the reverse-time data process with a velocity model comprising predetermined subsurface velocity information associated with subsurface locations. And another aspect comprises a display device for displaying the dynamic particle parameters. Still another aspect involves the information handling system wherein the time-reversed-model-attribute is an output value from an imaging condition applied to the plurality of dynamic particle parameters. The processor of the information handling system of may be configured to apply the reverse-time data process with an extrapolator for at least one selected from the group of i) finite-difference reverse time migration, ii) ray-tracing reverse time migration and iii) pseudo-spectral reverse time migration. And the information handling system may further comprise a graphical display coupled to the processor and configured to present a view of the time-reversed-model-attribute as a function of position, wherein the processor is configured to generate the view by contouring values of the time-reversed-model-attribute over an area associated with the seismic data.

In one nonlimiting embodiment a method for processing synchronous array seismic data comprises acquiring seismic data from a plurality of sensors to obtain synchronized array measurements, acquiring a non-signal noise-dataset, applying a reverse-time data process to the synchronized array measurements and to the non-signal noise-dataset to obtain a plurality of dynamic particle parameters associated with subsurface locations comprising a real dynamic dataset and a synthetic dynamic dataset, applying an imaging condition, using a processing unit, to the dynamic particle parameters of the real and synthetic datasets to obtain a real image dataset and a synthetic image dataset and scaling the real image dataset by a function of the synthetic image dataset to obtain an Image-domain Signal-to-Noise Estimate dataset.

In another aspect the method comprises scaling the non-signal noise dataset by an RMS value associated with the synchronized array measurements. Still another aspect comprises storing the Image-domain Signal-to-Noise Estimate dataset in a form for display. Yet another aspect comprises applying wave field decomposition to the real dynamic dataset and the synthetic dynamic dataset. In another aspect of the method the acquired seismic data are at least one selected from the group consisting of i) particle velocity measurements, ii) particle acceleration measurements and iii) particle pressure measurements. The method also may comprise summing the Image-domain Signal-to-Noise Estimate dataset along a selected interval to obtain a time reverse model attribute. Another aspect of the method comprises applying a zero-phase frequency filter to the synchronized array measurements.

In another nonlimiting embodiment a set of application program interfaces embodied on a computer readable medium for execution on a processor in conjunction with an application program for applying a reverse-time data process to synchronized seismic data array measurements to obtain a Image-domain Signal-to-Noise Estimate dataset for locating subsurface reservoirs comprises a first interface that receives synchronized seismic data array measurements, a second interface that receives random seismic data measurements to comprise a non-signal noise dataset, a third interface that receives a plurality of dynamic particle parameters associated with subsurface locations to obtain a real dynamic dataset, the parameters output from reverse-time data propagation of the synchronized seismic data array measurements, a fourth interface that receives a plurality of dynamic particle parameters associated with subsurface locations to obtain a synthetic dynamic dataset, the parameters output from reverse-time data processing of the non-signal noise dataset, a fifth interface that receives a real image dataset, the real image dataset output from applying a first image condition to the real dynamic dataset, a sixth interface that receives a synthetic image dataset, the synthetic image dataset output from applying a second image condition to the synthetic dynamic dataset and a seventh interface that receives instruction data for scaling the real image dataset by a function of the synthetic image dataset to obtain a Image-domain Signal-to-Noise Estimate dataset.

Another aspect of the set of application interface programs comprises a depth-stacking interface that receives instruction data for the Image-domain Signal-to-Noise Estimate dataset over a selected depth interval to obtain a time reverse model attribute. Yet another aspect comprises an RMS-scaling interface that receives instruction data for applying an RMS value associated with the synchronized array measurements to the non-signal noise dataset. In another aspect the set of application interface programs comprises a seismic-data-input interface that receives instruction data for the input of the plurality of dynamic particle parameters that are at least one selected from the group consisting of i) particle velocity measurements, and ii) particle acceleration measurements and iii) particle pressure measurements. In still another aspect the set of application interface programs comprises a velocity-model interface that receives instruction data for processing using a predetermined velocity structure. Another aspect comprises a display interface that receives instruction data for displaying imaging-condition processed values of the plurality of dynamic particle parameters. And another aspect of the set of application interface programs according comprises a wave field decomposition interface that receives instructions data for applying wave field decomposition to the real dynamic dataset and the synthetic dynamic dataset.

In still another nonlimiting embodiment an information handling system for determining a subsurface image dataset for associated with an area of seismic data acquisition comprises a processor configured for applying a reverse-time data process to synchronized array measurements of seismic data and a non-signal noise dataset to obtain dynamic particle parameters associated with a real dynamic dataset and a synthetic dynamic dataset, a processor configured for applying an imaging condition, using a processing unit, to the dynamic particle parameters of the real and synthetic datasets to obtain a real image dataset and a synthetic image dataset, a processor configured for scaling the real image dataset by a function of the synthetic image dataset to obtain a Image-domain Signal-to-Noise Estimate dataset and a computer readable medium for storing the Image-domain Signal-to-Noise Estimate dataset.

In another aspect of the information handling system, the processor is configured to apply the reverse-time data process with a velocity model comprising predetermined subsurface velocity information associated with subsurface locations. In still another aspect the information handling system comprises a display device for displaying the Image-domain Signal-to-Noise Estimate dataset. The information handling system in another aspect comprises a processor for scaling the non-signal noise dataset by an RMS value associated with the synchronized array measurements. In yet another aspect the information handling system comprises a processor configured to apply the reverse-time data process with an extrapolator for at least one selected from the group of i) finite-difference reverse time migration, ii) ray-tracing reverse time migration and iii) pseudo-spectral reverse time migration. The information handling system in yet another aspect comprises a processor configured to sum the Image-domain Signal-to-Noise Estimate dataset over a selected interval to obtain a time reverse model attribute.

While various embodiments have been shown and described, various modifications and substitutions may be made thereto without departing from the spirit and scope of the disclosure herein. Accordingly, it is to be understood that the present embodiments have been described by way of illustration and not limitation.

We claim:

1-20. (canceled)

21. A method for processing synchronous array seismic data comprising:
a) acquiring seismic data from a plurality of sensors positioned in a borehole to obtain synchronized array measurements;
b) acquiring a non-signal noise-dataset;
c) applying a reverse-time data process to the synchronized array measurements and to the non-signal noise-dataset to obtain a plurality of dynamic particle parameters associated with subsurface locations comprising a real dynamic dataset and a synthetic dynamic dataset;
d) applying an imaging condition, using a processing unit, to the dynamic particle parameters of the real and synthetic datasets to obtain a real image dataset and a synthetic image dataset; and
e) scaling the real image dataset by a function of the synthetic image dataset to obtain an Image-domain Signal-to-Noise Estimate dataset.

22. The method of claim 1 further comprising acquiring the synchronized array measurements with a three dimensional surface sensor array.

23. The method of claim 1 further comprising scaling the non-signal noise dataset by an RMS value associated with the synchronized array measurements.

24. The method of claim 1 further comprising storing the Image-domain Signal-to-Noise Estimate dataset in a form for display.

25. The method of claim 1 further comprising applying wave field decomposition to the real dynamic dataset and the synthetic dynamic dataset.

26. The method of claim 1 wherein the acquired seismic data are at least one selected from the group consisting of i) particle velocity measurements, ii) particle acceleration measurements and iii) particle pressure measurements.

27. The method of claim 1 further comprising summing the Image-domain Signal-to-Noise Estimate dataset along a selected interval to obtain a time reverse model attribute.

28. A set of application program interfaces embodied on a computer readable medium for execution on a processor in conjunction with an application program for applying a reverse-time data process to synchronized seismic data array measurements to obtain a Image-domain Signal-to-Noise Estimate dataset for locating subsurface reservoirs comprising:
a first interface that receives synchronized seismic data array measurements from sensors positioned in a borehole;
a second interface that receives random seismic data measurements to comprise a non-signal noise dataset;
a third interface that receives a plurality of dynamic particle parameters associated with subsurface locations to obtain a real dynamic dataset, the parameters output from reverse-time data propagation of the synchronized seismic data array measurements;
a fourth interface that receives a plurality of dynamic particle parameters associated with subsurface locations to obtain a synthetic dynamic dataset, the parameters output from reverse-time data processing of the non-signal noise dataset;
a fifth interface that receives a real image dataset, the real image dataset output from applying a first image condition to the real dynamic dataset;
a sixth interface that receives a synthetic image dataset, the synthetic image dataset output from applying a second image condition to the synthetic dynamic dataset; and
a seventh interface that receives instruction data for scaling the real image dataset by a function of the synthetic image dataset to obtain a Image-domain Signal-to-Noise Estimate dataset.

29. The set of application interface programs according to claim 8 further comprising:
a depth-stacking interface that receives instruction data for the Image-domain Signal-to-Noise Estimate dataset over a selected depth interval to obtain a time reverse model attribute.

30. The set of application interface programs according to claim 8 further comprising:
an RMS-scaling interface that receives instruction data for applying an RMS value associated with the synchronized array measurements to the non-signal noise dataset.

31. The set of application interface programs according to claim 8 further comprising:
a seismic-data-input interface that receives instruction data for the input of the plurality of dynamic particle parameters that are at least one selected from the group consisting of i) particle velocity measurements, and ii) particle acceleration measurements and iii) particle pressure measurements.

32. The set of application interface programs according to claim 8 further comprising:
a velocity-model interface that receives instruction data for processing using a predetermined velocity structure.

33. The set of application interface programs according to claim 8 further comprising:
a display interface that receives instruction data for displaying imaging-condition processed values of the plurality of dynamic particle parameters.

34. The set of application interface programs according to claim 8 further comprising:
a wave field decomposition interface that receives instructions data for applying wave field decomposition to the real dynamic dataset and the synthetic dynamic dataset.

35. An information handling system for determining a subsurface image dataset for associated with an area of seismic data acquisition comprising:
a) a processor configured for applying a reverse-time data process to synchronized array measurements of seismic data acquired with sensors positioned in a borehole and a non-signal noise dataset to obtain dynamic particle parameters associated with a real dynamic dataset and a synthetic dynamic dataset;
b) a processor configured for applying an imaging condition, using a processing unit, to the dynamic particle parameters of the real and synthetic datasets to obtain a real image dataset and a synthetic image dataset;
c) a processor configured for scaling the real image dataset by a function of the synthetic image dataset to obtain a Image-domain Signal-to-Noise Estimate dataset; and
d) a computer readable medium for storing the Image-domain Signal-to-Noise Estimate dataset.

36. The information handling system of claim 15 wherein the processor is configured to apply the reverse-time data process with a velocity model comprising predetermined subsurface velocity information associated with subsurface locations.

37. The information handling system of claim 15 wherein the processor is further configured for applying a reverse-time data process to synchronized array measurements of seismic data acquired with a three dimensional surface sensor array to obtain dynamic particle parameters associated with subsurface locations.

38. The information handling system of claim 15 further comprising a processor for scaling the non-signal noise dataset by an RMS value associated with the synchronized array measurements.

39. The information handling system of claim 15 further comprising a processor configured to apply the reverse-time data process with an extrapolator for at least one selected from the group of i) finite-difference reverse time migration, ii) ray-tracing reverse time migration and iii) pseudo-spectral reverse time migration.

40. The information handling system of claim 15 further comprising:
a processor configured to sum the Image-domain Signal-to-Noise Estimate dataset over a selected interval to obtain a time reverse model attribute.
